(19) United States
(12) Patent Application Publication
(10) Pub. No.: US 2007/0147325 A1
(43) Pub. Date: Jun. 28, 2007

(54) Terminal for accessing network, wireless access module and method thereof

(75) Inventors: Jun-Sik Kim, Seongnam-city (KR); Nam-Hoon Park, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Yuseong-gu (KR); KT Corporation, Seongnam-city (KR); SK TELECOM CO., LTD., Seoul (KR); HANARO TELECOM., INC., Seoul (KR)

(21) Appl. No.: 11/607,274

(22) Filed: Dec. 1, 2006

(30) Foreign Application Priority Data
Dec. 1, 2005 (KR) 2005-116236

(51) Int. Cl. H04Q 7/24

(52) U.S. Cl. 370/338; 713/168

(57) ABSTRACT

In a wireless access module in a terminal, a user interface unit for receiving information for managing network access is provided. A terminal function performing unit performs an authentication process for accessing the network and sets a network address according to the information from the user interface unit. A terminal control unit supports the terminal to access the network based on the authentication and the network address, and a wireless access unit performs a communication function with the network.

### PRIORITY

This application claims priority to and the benefit of Korean Patent Application No. 10-2005-0116236 filed in the Korean Intellectual Property Office on Dec. 1, 2005, the entire contents of which are incorporated herein by reference.

### BACKGROUND OF THE INVENTION

1. Field of the Invention

The present invention relates to a terminal for accessing a network, a wireless access module and a method thereof. More particularly, the present invention relates to a wireless access module and a wireless access method for accessing a portable Internet.

2. Description of the Related Art

As electronic and communication technology is being developed, various wireless communication service using a wireless network have been provided. One of the most basic wireless communication services is a wireless voice communication service that can provide voice communication to mobile subscriber station users irrespective of time and location. In addition, a text message service is provided in order to complement the voice communication service. Recently, a wireless Internet service that provides an Internet communication service to users of a mobile subscriber station by a wireless communication network has been developed. The service provided by a mobile communication system has been enlarged to a multimedia communication service that can transmit a circuit data and packet data as well as a voice data.

In order to provide such services, the mobile communication service has developed into an advanced mobile phone system (AMPS) using an analog service scheme (i.e., the first generation mobile communication service), a global system for mobile communications (GSM) and a code division multiple access (CDMA) system using a digital service scheme (i.e., the second generation mobile communication service), and a personal communication service (PCS) as the 2.5 generation mobile communication service. Recently, international mobile telecommunication 2000 (IMT-2000) that is established as a standard, is commercially available as the third generation mobile communication service.

The IMT-2000 is classified into a wideband CDMA (WCDMA) system using an asynchronous scheme suggested by 3rd Generation Partnership Project (3GPP) and a CDMA-2000 (e.g., CDMA 2000 1X, 3X, and EV-DO) using a synchronous scheme suggested by 3GPP2.

Wireless access technology and mobile communication network technology of the CDMA-2000 system are based on the CDMA scheme. Because the CDMA-2000 system has backward compatibility with international standard (IS-95) network that is a conventional second generation communication network, it can provide a mobile communication service using both communication networks of the second generation and the third generation. In addition, the CDMA-2000 system can provide a mobile Internet Protocol (mobile IP) function similar to hand-off of a voice communication and a roaming service using a Removable User Identity Module (R-UIM).

While the wireless access technology of the WCDMA system uses a CDMA scheme, the mobile communication network technology is based on a network technology of GSM. The WCDMA communication scheme is suitable for a high-rate data transmission due to a wide frequency bandwidth of 5 MHz and a data transmission speed of 2 Mbps, and exhibits a good performance of communication and data transmission even in a bad communication environment due to diversity according to a backward communication quality that cannot be provided in a conventional IS-95 and GSM scheme.

The WCDMA communication scheme is adapted by most nations, and 3GPP are continuously improving technology for WCDMA, so nations providing the CDMA-2000 service such as Korea, USA, and China have begun to provide the WCDMA service.

As the wireless Internet service has become activated, a high-speed wireless Internet service in a mobile communication environment has been highly requested. However, a conventional mobile communication system demands a high charge for using a wireless Internet due to a high cost for establishing a base station and has limitations for available contents due to a small terminal display, and thus it has limits for providing a high-speed wireless Internet service. Accordingly, portable Internet systems such as a Wireless Broadband (WiBro) and a High Speed Downlink Packet Access (HSDPA) which can be used for the wireless Internet service with portability, mobility, and a low service charge have been developed.

A terminal control scheme consistent with the conventional mobile communication technology is accessed by an application running in an operation system (OS) in a terminal at a simple wireless access environment without mobility such as a wireless local area network (WLAN) or by a integrated terminal, and thus it has some limitations for unlimited usage of Internet at a mobile communication environment.

Recently developing portable Internet systems can provide both mobility and high-speed data communication. A terminal of the portable Internet system has a basic terminal function for accessing a portable Internet independently, and furthermore, it also includes a function that can support wireless access for the portable Internet by connecting with another terminal such as a laptop, a PDA, or a smart phone.

In order to access to the portable Internet, the terminal for the wireless access needs to perform processes provided for a conventional wire Internet network (e.g., authentication, security, and a quality of service (QoS)) and for wireless data communication access (e.g., mobility control, wireless link access control). For this purpose, the terminal needs a wireless access module for the portable Internet, that efficiently controls and manages the access to the portable Internet consistent with a portable Internet access request of a user.

The above information disclosed in this Background section is only for enhancement of understanding of the background of the invention and therefore it may contain information that does not form the prior art that is already known a person of ordinary skill in the art.

### SUMMARY OF THE INVENTION

The present invention has been made in an effort to provide a wireless access module of a terminal for accessing a network and a method thereof having advantages of managing a network access process by controlling authentication for accessing the network, security, determination of a QoS, mobility, and wireless link access according to user's demands.

The present invention provides a wireless access module of a terminal, the wireless access module includes a user interface unit for receiving information for managing network access; a terminal function performing unit for performing authentication process for accessing the network and setting a network address determining process according to the information from the user interface unit; a terminal control unit for supporting the terminal to access the network based on the authentication and the network address; and a wireless access unit for communicating with the network according to a control of the terminal control unit.

The present invention provides a wireless access method of a terminal for accessing a network. The method includes outputting at least one access environment information of the network; setting a communication mode for the network according to a selected access environment information; performing authentication process with the network according to the selected access environment information; receiving network address information according to the selected access environment information; and accessing the network by using the received network address information.

The present invention provides a terminal including means for providing an interface for managing a network access; means for performing an authentication process for accessing the network and setting a network address according to an information from the interface; means for supporting the access to the network according to the authentication and the network address; and means for communicate with the network.

### BRIEF DESCRIPTION OF THE DRAWINGS

FIG. 1 is a block diagram showing an internal structure of a terminal accessing a portable Internet according to the present invention.

FIG. 2 is a block diagram showing a structure of a wireless access module that is provided in a terminal according to the present invention.

FIG. 3 shows a structure of a protocol that is transmitted from a wireless access module of a portable terminal for accessing a portable Internet according to an exemplary embodiment of the present invention.

FIG. 4 is a flowchart for showing a wireless access method to a portable Internet according to the present invention.

### THE EMBODIMENT OF THE PRESENT INVENTION

In the following detailed description, only certain preferred embodiments of the present invention have been shown and described, simply by way of illustration. As those skilled in the art would realize, the described embodiments may be modified in various ways, all without departing from the spirit or scope of the present invention. Accordingly, the drawings and description are to be regarded as illustrative in nature and not restrictive. Like reference numerals designate like elements throughout the specification.

Throughout this specification and the claims which follow, a module or a block means at least one unit that performs a specific function or operation, and can be realized by hardware or software, or a combination of both.

In preferred embodiments of the present invention, a network address allocated for accessing network will be described as an Internet protocol (IP) address, and a network will be described as a portable Internet.

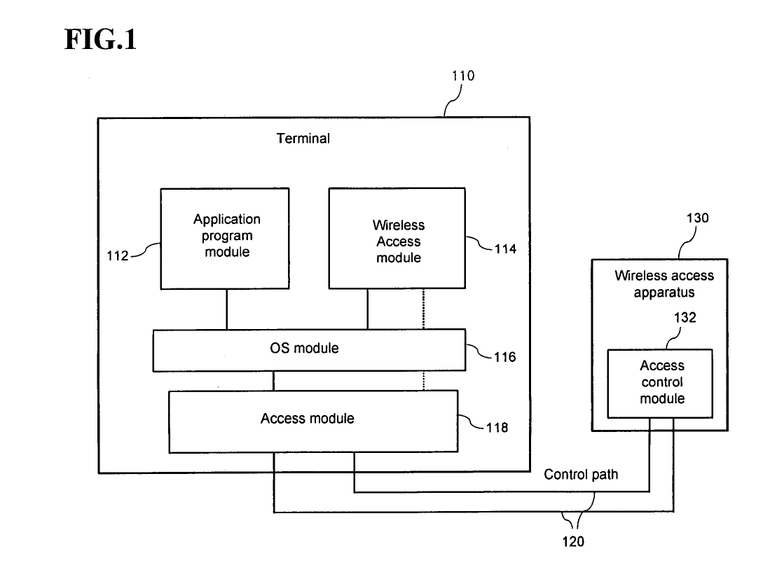

FIG. 1 is a block diagram showing a terminal for accessing a portable Internet according to an embodiment of the present invention.

A terminal 110 is provided with Internet service by a portable Internet according to the embodiment of the present invention. The terminal 110 includes an application program module 112, a wireless access module 114, an operating system (OS) module 116, and an access module 118. A wireless access apparatus 130 for connecting the terminal 110 to the portable Internet includes an access control module 132, and is connected to the terminal 110 through a control path 120.

At the application program module 112 of the terminal 110, various application programs are performed by an OS of the terminal 110.

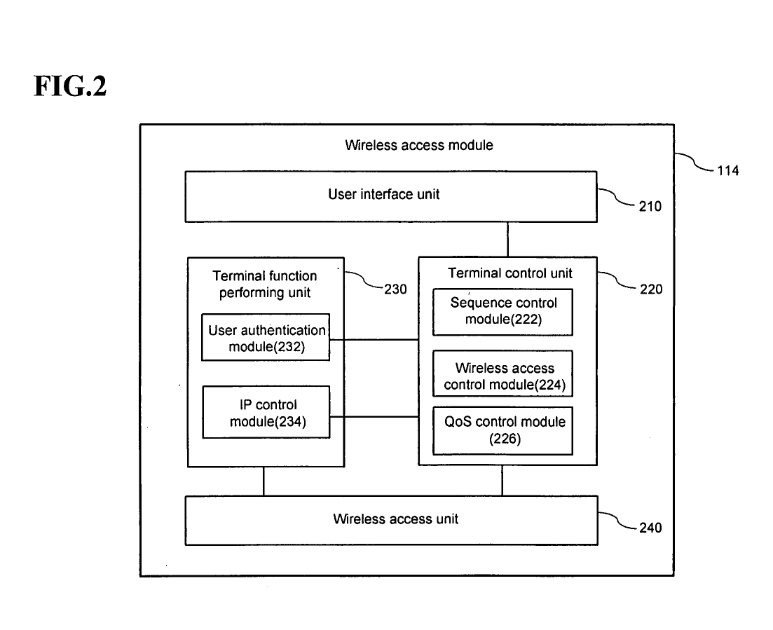

At the wireless access module 114, a control program is executed. The control program controls authentication, security, setting of quality of service (QoS), mobility, and wireless link access according to a user's request in order to connect the terminal 110 to the portable Internet. The wireless access module 114 is connected to the wireless access apparatus 130 through an access module 118, and controls the access control module 132 of the wireless access apparatus 130. For this purpose, the wireless access module 114 is directly connected to the access module 118 as shown by the dotted line. The detail structure of the wireless access module 114 will be described referring to FIG. 2.

The OS module 116 includes an OS for operating the terminal 110 by controlling and processing various programs. For example, Microsoft Windows, Apple Mac OS, AT&T Unix, Linux, and Palm OS can be used as the OS.

The application program module 112 and the wireless access module 114 operate based on the OS base executed in the OS module 116.

The access module for wireless access apparatus 118 is connected to the wireless access apparatus 130, and can include a PCMCIA (Personal Computer Memory Card International Association) slot, a USB (Universal Serial Bus) terminal, and so on.

The wireless access apparatus 130 performs IP-based wireless data communication with the portable Internet, and is connected to the PCMCIA slot and the USB terminal of the access module 118. For this purpose, the wireless access apparatus 130 can be provided as a PCMCIA card, a USB stick, or so on.

The access control module 132 receives control signals that are transmitted from the access module 118 through the control path 120, and then controls the operation of the wireless access apparatus 130.

FIG. 2 is a block diagram showing a structure of a wireless access module that is provided in a terminal according to the embodiment of the present invention.

The wireless access module 114 of the terminal 110 consistent with the embodiment of the present invention includes a user interface unit 210, a terminal control unit 220, a terminal function performing unit 230, and a wireless access unit 240.

The user interface unit 210 provides an interface so that a user can input typical network management parameters and user information, and displays an access process and a processing status so that a user can control a network access status. The user interface unit 210 receives from a user information for managing network access.

The terminal control unit 220 includes a sequence control module 222 that controls the sequence of the wireless access, a wireless access control module 224 that provides access environment information of the network that is set at the user's current location, and a QoS control module 226 for setting QoS according to request of the user.

The terminal function performing unit 230 performs an authentication process such as RSA (Rivest Shamir Adleman) or EAP (Extensible Authentication Protocol) when the terminal 110 connects to the portable Internet, and includes a user authentication module 232 that includes a detailed function such as a key controlling function and an IP control module 234 for performing an IP control function.

The IP control function includes a function for setting IP topology and a function for supporting a mobile IP (MIP). The function for setting IP topology is a function for allocating an IP address when a user arbitrarily access to network. The function for supporting the MIP includes an IP hand-over processing based on the MIP, an MIP registration, an MIP advertisement message processing, and an MIP solicitation.

The wireless access unit 240 performs a communication function with the wireless access apparatus 130 through the access module 118.

The terminal 110 is connected to the wireless access apparatus 130 by a general-purpose interface such as a PCMCIA or a USB. The wireless access unit 240 performs the communication function with the wireless access apparatus 130 through the general-purpose interface and provides various modules and applications in the terminal 110 with a communication application program interface (API).

In addition, the wireless access unit 240 provides a user data path and a control path. The wireless access unit 240 provides a Network Device Interface Specification (NDIS) interface of the OS module 116 for the flow of user data, and provides a TCP (Transmission Control Protocol)/UDP (User Datagram Protocol)/IP packet communication path by linking to IP layer of the terminal 110.

In addition, the wireless access unit 240 provides another API for control messages apart from the UDP/IP packet path. In one embodiment, the control message is not an IP packet format but a separately defined message for performing functions of the terminal 110 accessing the portable Internet.

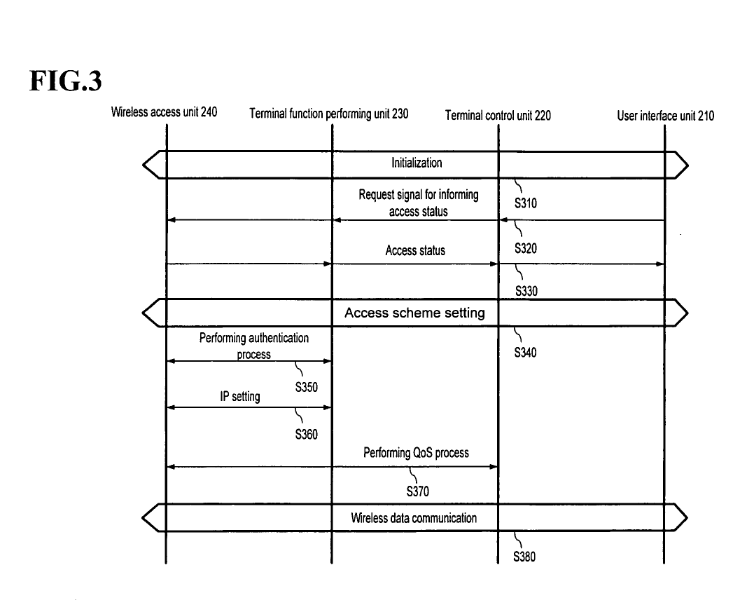

FIG. 3 shows a structure of a protocol that is transmitted from a wireless access module of a terminal for accessing a portable Internet according to the embodiment of the present invention.

After the terminal 110 is initialized by power-on or a program for accessing the portable Internet at step S310, the user interface unit 210 sends a request signal to the wireless access apparatus 130 through the terminal control unit 220, the terminal function performing unit 230 and the wireless access unit 240 as step S320. The request signal is a signal for requesting access status about—parameters of the terminal that is set by a user.

After receiving the request signal for informing access status, the wireless access apparatus 130 confirms the access status to the portable Internet and transmits the access status to the user interface unit 210 through the wireless access unit 240, the terminal function performing unit 230, and the terminal control unit 220 at step S330. The access status is transmitted according to a user's order or a predetermined period.

When information of the access status is displayed on the user interface unit 210, an access scheme to the portable Internet is set up by considering collected data at step S340.

After the access scheme is set, the terminal 110 performs a network access process. In order to access to the portable Internet, an authentication process is performed as step S350. The authentication process is performed by RSA or EAP between the wireless access control module 224 of the terminal control unit 220, the user authentication module 232 of the terminal function performing unit 230 and the authentication server (AAA: Authentication, Authorization, Accounting) included in the portable Internet.

When the authentication process by the user authentication module 232 is completed, at step S360, the IP control module 234 sets IP address based on a Dynamic Host Configuration Protocol (DHCP) or MIP, which is set by the user according to a scheme provided by the portable Internet.

When the terminal 110 is connected to the portable Internet of the terminal 110 by the authentication and IP address setting process, the QoS control module 226 selects and registers a required QoS consistent with a QoS process at step S370. And then, a wireless data communication begins at step S380.

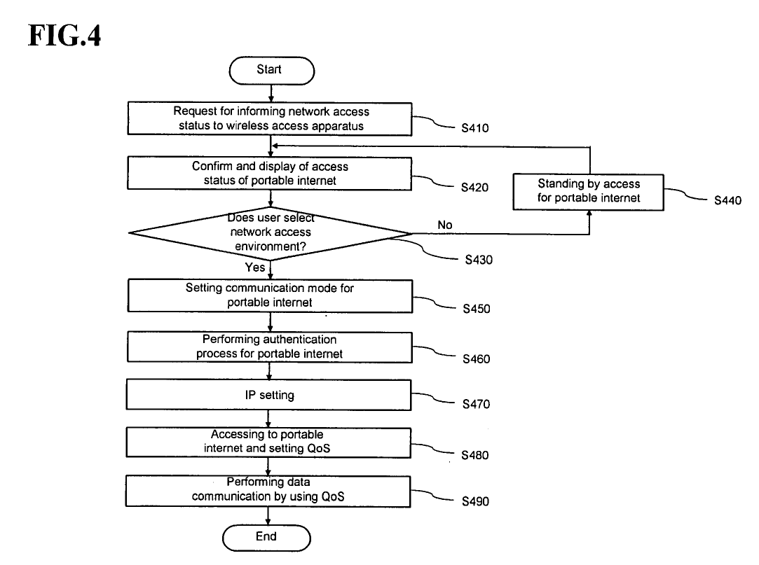

FIG. 4 is a flowchart for showing a wireless access method to a portable Internet according to the embodiment of the present invention.

In order to access the portable Internet, the terminal 110 sets parameters related with access environment of the portable Internet by the user interface unit 210 of the wireless access module 114. Subsequently, the terminal 110 sends request signal for informing a network access status to the wireless access apparatus 130 that tries to connect to the portable Internet sends at step S410.

The wireless access apparatus 130 confirms the access status to the portable Internet and transmits the access status to the user interface unit 210, and then the user interface unit 210 displays information of the network access environment to the user of the terminal 110 at step S420. The user of the terminal 110 checks the displayed information of the network access environment and determines whether to access the network. At this time, the user can select a desired network access environment among various displayed information of the network access environment at step S430.

When the user does not want to access the portable Internet, the terminal 110 provides the user with other service by the application program module 112 and waits for access to the portable Internet. At step S440, the terminal 110 may periodically display information of the network access environment or display the information of the network access environment in response to user's request.

When the user confirms desired information of the network access environment at step S420 or S440, the user sets a communication mode for the portable Internet at step S450. When the communication mode for the portable internet is set for the terminal 110, an authentication process with AAA in the portable Internet by the user authentication module 232 is performed according to a network access process controlled by the sequence control module 222 at step S460.

After the authentication process, at step S470, IP address information is received from the portable Internet, and an IP address is set according to the received IP address information by the IP control module 234. The terminal 110 may receive IP address information for a wireless Internet service from an access control router (ACR) of a portable Internet.

When the authentication and the IP address setting process is completed so that the terminal 110 is connected to the portable Internet, a QoS of an Internet service to be provided is selected, and an approval and access request process for the selected QoS is performed at step S480. Accordingly, the terminal 110 performs data communication by using the QoS approved by the portable Internet at step S490.

Although it was described above that the user sets the communication mode and the QoS for the portable Internet for the step S430 and the step S480, basic parameters for the communication mode and the QoS can be stored in the wireless access module 114, and thus they can be automatically selected by the wireless access module 114 without user control.

The terminal can access a portable Internet and be provided with the Internet service by using the wireless access scheme as described above.

According to the embodiment of the present invention, applications provided to a terminal can be efficiently controlled while accessing an Internet network by a wireless method. In addition, the terminal that was provided with Internet service only by a wired Internet network can be connected with a wireless access apparatus by a general accessing method and can access a portable Internet by the wireless access apparatus. Consequently, a user can use a conventional terminal without change of environment such as a terminal and be provided with a wireless Internet service by using a conventional application program.

The above-described preferred embodiments of the present invention can be realized not only through a method and an apparatus, but also through a program that can perform functions corresponding to configurations of the preferred embodiments of the present invention or a recording medium storing the program, and this can be easily realized by a person skilled in the art.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A wireless access module of a terminal, the wireless access module comprising:
a user interface unit for receiving information for managing network access;
a terminal function performing unit for performing an authentication process for accessing the network and setting a network address according to the information;
a terminal control unit for controlling the terminal to access the network based on the authentication and the network address; and
a wireless access unit for communicating with the network under control of the terminal control unit.

2. The wireless access module of claim 1, wherein the terminal function performing unit comprises:
a user authentication module for performing the authentication process for accessing the network; and
a control module for setting the network address allocated from the network.

3. The wireless access module of claim 2, wherein the network address comprises an Internet protocol (IP) address.

4. The wireless access module of claim 3, wherein the control module sets the network address allocated from the network, processes an IP handover, registers a mobile IP, processes a mobile IP advertisement message, and performs a mobile IP.

5. The wireless access module of claim 1, wherein the terminal control unit comprises:
a sequence control module for controlling an access process to the network;
a wireless access control module for providing access environment information of the network that is measured at a location of the terminal; and
a quality of service (QoS) control module for setting a QoS for communicating with the network.

6. The wireless access module of claim 1, wherein the wireless access unit provides a communication application program interface for a general-purpose interface access, a transmission control protocol/user datagram protocol/Internet protocol (TCP/UDP/IP) packet communication path for transmitting and receiving data, and an application program interface for generating and transmitting a control message of the terminal.

7. A method of accessing a network in a terminal, the method comprising:
selecting at least one access environment of the network;
setting a communication mode for the network according to the selected access environment information;
performing an authentication process with the network according to the selected access environment information;
receiving network address information according to the selected access environment information; and
accessing the network by using the received network address information.

8. The method of claim 7, further comprising:
setting a quality of service that will be provided from the network; and
performing data communication by using the quality of service.

9. The method of claim 8, wherein the quality of service comprises one of a quality of service selected by a terminal user and a quality of service stored in the terminal.

10. The method of claim 7, wherein the setting of the communication mode comprises receiving the selected access environment information from a terminal user.

11. The method of claim 7, wherein RSA (Rivest Shamir Adleman) or EAP (Extensible Authentication Protocol) is used for performing the authentication process with an AAA (Authentication, Authorization, Accounting) server of the network.

12. The method of claim 7, wherein the communication mode comprises one of a communication mode selected by a terminal user and a communication mode stored in the terminal.

13. A terminal, comprising:
means for providing an interface for managing a network access;
means for performing an authentication process for accessing the network and setting a network address according to information from the interface;
means for supporting access to the network according to the authentication and the network address; and
means for communicate with the network.

14. The terminal of claim 13, further comprising:
means for providing access environment information of the network that is measured at the current location; and
means for setting a quality of service for communicating with the network.
